(19) United States
(12) Patent Application Publication
(10) Pub. No.: US 2026/0218974 A1
(43) Pub. Date: Jul. 30, 2026

(54) REFRIGERATOR CAPABLE OF PREVENTING DEW CONDENSATION AND METHOD THEREFOR

(71) Applicant: SAMSUNG ELECTRONICS CO., LTD., Suwon-si (KR)

(72) Inventors: Hyejeong OH, Suwon-si (KR); Joohee Song, Suwon-si (KR); Sangyoul Cha, Suwon-si (KR)

(73) Assignee: SAMSUNG ELECTRONICS CO., LTD., Suwon-si (KR)

(21) Appl. No.: 19/629,196

(22) Filed: Mar. 26, 2026

Related U.S. Application Data
(63) Continuation of application No. PCT/KR2024/014970, filed on Oct. 2, 2024.

(30) Foreign Application Priority Data
Oct. 26, 2023 (KR) 10-2023-0144822

(51) Int. Cl. F25D 21/04; F25D 23/02

(52) U.S. Cl. CPC F25D 21/04; F25D 23/028

(57) ABSTRACT

A refrigerator including: a main body having a storage chamber, two doors rotatably connected to the main body and each configured to open or close the storage chamber, a rotation bar disposed on at least one of the two doors and configured to seal a space between the two doors when the two doors close the storage chamber, and a top cover disposed on an upper portion of the main body, wherein the top cover comprises: a suction port configured to allow communication between an inner space of the top cover and an outside of the top cover, and a fan configured to suction external air through the suction port and discharge the external air toward the rotation bar.

### CROSS-REFERENCE TO RELATED APPLICATIONS

This application is a continuation of International Application No. PCT/KR2024/014970, filed on Oct. 2, 2024, which is based on and claims priority to Korean Patent Application No. 10-2023-0144822, filed on Oct. 26, 2023, in the Korean Intellectual Property Office, the disclosures of which are incorporated by reference herein in their entireties.

### BACKGROUND

### 1. Field

The present disclosure relates to a refrigerator capable of preventing dew condensation and a method therefor.

### 2. Description of Related Art

As technology related to refrigerators advances and aesthetic standards for home appliances increase, products having various designs have been developed to supply designs desired by users rather than a uniform design. Among these products, a French door-type refrigerator may additionally include a configuration capable of sealing a space between double doors to prevent cold air leakage from a storage chamber through the space between the doors. However, such a configuration may cause dew condensation on a surface of the refrigerator in contact with external air due to a temperature difference between a refrigerating chamber and external air.

### SUMMARY

According to an aspect of the disclosure, a refrigerator includes: a main body having a storage chamber; two doors rotatably connected to the main body and each configured to open or close the storage chamber; a rotation bar disposed on at least one of the two doors and configured to seal a space between the two doors when the two doors close the storage chamber; and a top cover disposed on an upper portion of the main body, wherein the top cover comprises: a suction port configured to allow communication between an inner space of the top cover and an outside of the top cover, and a fan configured to suction external air through the suction port and discharge the external air toward the rotation bar.

The refrigertor may include at lesat one processor, wherein the rotation bar includes a heater, and wherein the at least one processor is configured to control at least one of the fan and the heater.

The heater may be disposed along a length direction of the rotation bar and is segmented into a plurality of regions, and the at least one processor may be configured to individually adjust an intensity of each of the plurality of regions of the heater based on a vertical distance between the top cover and each of the plurality of regions of the heater.

The top cover may further include a sensor configured to measure at least one of temperature or humidity and the at least one processor may be configured to determine whether to drive the fan and each of the plurality of regions of the heater based on a measurement value obtained from the sensor.

The rotation bar may further include a plurality of sensors respectively disposed in the plurality of regions and configured to measure at least one of temperature or humidity and the at least one processor may be configured to individually adjust the intensity of each of the plurality of regions of the heater based on a measurement value obtained from each of the plurality of sensors.

The fan may be disposed at a center of the top cover corresponding to an upper end of the rotation bar and the fan may include a discharge port configured to directly discharge air flow toward the rotation bar.

The fan may include a plurality of fans. The plurality of fans may be disposed symmetrically on both sides of a center of the top cover. The top cover may include an air flow path connected to each of the plurality of fans to deliver the external air toward the rotation bar and the at least one processor may be configured to independently drive each of the plurality of fans.

According to an embodiment of the present disclosure, a method for preventing dew condensation in a refrigerator includes: measuring at least one of temperature or humidity of external air around the refrigerator; driving a fan disposed on a top cover to introduce the external air toward a rotation bar that seals a space between a first door and a second door of the refrigerator when a sensing value for the external air deviates from a predetermined environment condition; and driving a heater included in the rotation bar to prevent dew condensation from occurring on the rotation bar.

The heater may be disposed along a length direction of the rotation bar and is segmented into a plurality of regions, and driving the heater to prevent the dew condensation from occurring on the rotation bar may comprise independently driving each of the plurality of regions of the heater to allow an intensity of the heater to increase in proportion to a vertical distance between the top cover and each of the plurality of regions of the heater.

The driving the heater to prevent the dew condensation from occurring on the rotation bar may comprise: identifying at least one of the temperature or the humidity based on sensing values obtained from a plurality of sensors respectively disposed in the plurality of regions; and adjusting an individual intensity of each of the plurality of regions of the heater based on the at least one of the temperature or the humidity.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a perspective view of a refrigerator according to an embodiment of the present disclosure;

FIG. 2 is a view illustrating an operation of a rotation bar in a state in which a door is closed and in a state in which a door is opened according to an embodiment of the present disclosure;

FIG. 3 is a rear perspective view of a top cover according to an embodiment of the present disclosure;

FIG. 4 is a view illustrating a portion in which a fan is fixed to the top cover according to an embodiment of the present disclosure;

FIG. 5A is a cross-sectional view taken along line A-A′ of FIG. 1;

FIG. 5B is an enlarged view illustrating a specific arrangement of the fan according to an embodiment of the present disclosure;

FIG. 6 is a cross-sectional view illustrating an internal configuration of the top cover according to another embodiment of the present disclosure;

FIG. 7 is a block diagram illustrating driving of the fan and heater of the refrigerator according to an embodiment of the present disclosure;

FIG. 8 is a view illustrating arrangement of a heater of the rotation bar according to an embodiment of the present disclosure;

FIG. 9 is a view illustrating a sensor according to an embodiment of the present disclosure;

FIG. 10 is a view illustrating that the sensor is embedded in the rotation bar according to another embodiment of the present disclosure;

FIG. 11 is a flowchart illustrating a method for preventing dew condensation in a refrigerator according to an embodiment of the present disclosure; and

FIG. 12 is a view illustrating a method for driving respective components included in the refrigerator according to an embodiment of the present disclosure.

### DETAILED DESCRIPTION

It should be understood that various embodiments of the present disclosure and terms used herein are not intended to limit technical features described in the present disclosure to specific embodiments, and rather are intended to include various modifications, equivalents, and substitutions of the corresponding embodiments.

Throughout the accompanying drawings, similar components are denoted by similar reference numerals.

A singular noun corresponding to an item is intended to include one or more of the items unless a relevant context clearly indicates otherwise.

In the present disclosure, an expression such as “A or B,” “at least one of A and B,” “at least one of A or B,” “A, B, or C,” “at least one of A, B, and C,” “at least one of A, B, or C,” or the like may include any one of the items listed together or all possible combinations thereof.

A term “and/or” includes a combination of a plurality of related described items or any one of the plurality of related described items.

Terms such as “first,” “second,” or the like may be used simply to distinguish one element and another element from each other, and do not limit the corresponding components in any other respect (e.g., importance or order).

When a component (for example, a first component) is mentioned to be “coupled with/to” or “connected to” another component (for example, a second component) with or without terms “operatively or communicatively,” it should be understood that the component may be directly coupled to another component (e.g., in a wired manner, in a wireless manner, or through a third component).

It should be further understood that terms “include,” “have” or the like, used in the specification specify the presence of features, numerals, steps, operations, components, parts mentioned in the specification or combinations thereof, and do not preclude the presence or addition of one or more other features, numerals, steps, operations, components, parts, or combinations thereof.

When a component is referred to as being “connected,” “coupled,” “supported,” or “in contact” with another component, it includes not only a case where the components are directly connected, coupled, supported, or in contact with each other, but also a case where the components are indirectly connected, coupled, supported, or in contact with each other through a third component.

When a component is referred to be disposed “on” another component, it includes not only a case where the component is in contact with another component, but also a case where still another component is interposed between the two components.

Hereinafter, a refrigerator according to various embodiments is described in detail with reference to the accompanying drawings

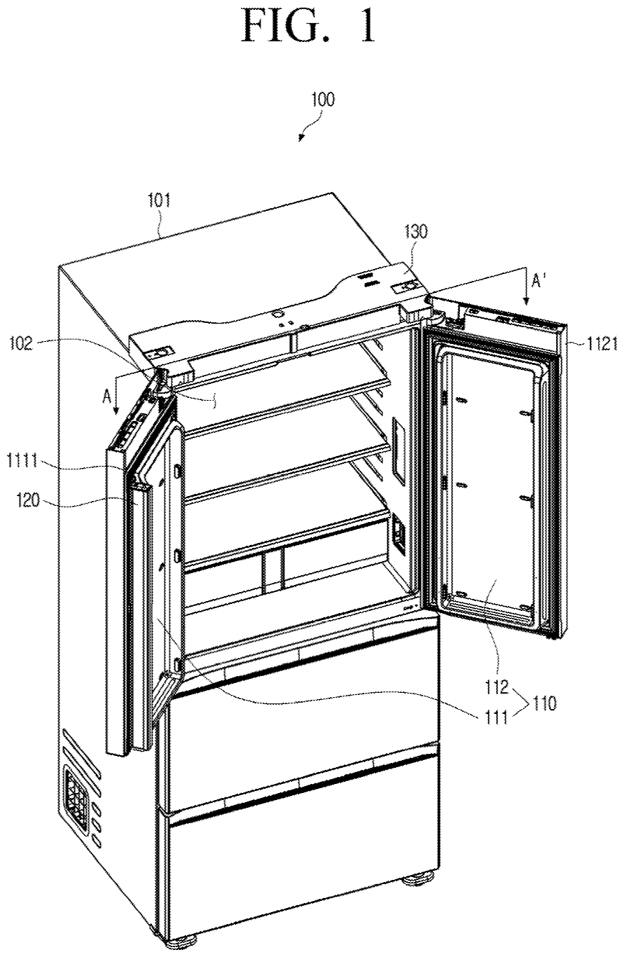

FIG. 1 is a perspective view of a refrigerator according to an embodiment of the present disclosure.

Referring to FIG. 1, a refrigerator 100 may include a main body 101, a storage chamber 102, a door 110, a rotation bar 120, and a top cover 130.

The refrigerator 100 may be classified into a French door type, a side-by-side type, a bottom mounted freezer (BMF), a top mounted freezer (TMF), or a one-door refrigerator depending on the arrangement of the door 110 and the storage chamber 102. Although the refrigerator 100 according to an embodiment of the present disclosure is described based on the French door type refrigerator, the refrigerator 100 is not necessarily limited thereto, and may be implemented as a refrigerator 100 having a plurality of doors 110 in contact with each other.

The main body 101 is a component that forms an overall exterior appearance and inner space of the refrigerator 100, and may include an inner case, an outer case disposed outside the inner case, and an insulating material disposed between the inner case and the outer case.

The inner case may include at least one of a case, a plate, a panel, or a liner forming the storage chamber 102. The inner case may be formed as a single body, or may be formed by assembling a plurality of plates.

The outer case may form the exterior appearance of the main body 101, and may be coupled to an outer side of the inner case to dispose the insulating material between the inner case and the outer case.

The insulating material may insulate the inside and outside of the storage chamber 102 from each other to maintain an internal temperature of the storage chamber 102 at a set appropriate temperature without being affected by an external environment of the storage chamber 102. The insulating material may be molded by injecting and foaming a urethane foam in which polyurethane and a foaming agent are mixed, and may further include a vacuum insulating material, or may be formed only of the vacuum insulating material. In this way, by disposing the insulating material between the inner case and the outer case of the main body 101, the temperature of the storage chamber 102 may be maintained to be lower than an external air temperature even when external air temperature is high.

The storage chamber 102 is a component for storing items requiring refrigeration such as food. The storage chamber 102 may include a space defined by the inner case of the main body 101.

Meanwhile, depending on a usage of the refrigerator 100, various items such as food, medicine, or cosmetics may be stored in the storage chamber 102, and the storage chamber 102 may have at least one side openable to allow items to be taken in or out.

The refrigerator 100 may include at least one storage chamber 102. When two or more storage chambers are included in the refrigerator 100, respective storage chambers 102 may have different uses and may be maintained at different temperatures. To this end, the respective storage chambers 102 may be partitioned from each other by a partition wall including an insulating material.

The storage chamber 102 may be opened by the door 110. The door 110 may be provided to open or close each of one or more storage chambers 102, or one door 110 may be provided to open or close a plurality of storage chambers 102. The door 110 may be rotatably or slidably installed on a front surface of the main body 101. The door 110 may seal the storage chamber 102 when the door 110 is closed. The door 110 may include an outer panel of the door that forms a front surface of the door 110, an inner panel of the door that forms a rear surface of the door 110 and faces the storage chamber 102, an upper cap, a lower cap, or the like.

The door 110 may include an insulating material between an inner case and an outer case, in the same manner as the main body 101, to insulate the storage chamber 102 when the door 110 is closed. When the door 110 includes the insulating material as described above, a surface temperature of the outer case of the door 110 that is in contact with external air may not decrease due to cold air in the storage chamber 102. Accordingly, a dew point of surface temperature of the outer case of the door 110 may not be lower than that of external air, thereby preventing dew condensation from occurring on the outer case of the door 110. A gasket may be disposed on an edge of the inner case of the door 110 and may be in close contact with one surface of the main body 101 when the door 110 is closed, thereby sealing the storage chamber 102.

The storage chamber 102 may be maintained within an appropriate temperature range based on a usage thereof, and may include a “refrigerating chamber,” a “freezing chamber,” or a “variable temperature chamber” that are classified based on the usage and/or the temperature range. The refrigerating chamber may be maintained at a temperature appropriate for refrigerating storage of items, and the freezing chamber may be maintained at a temperature appropriate for freezing storage of items. “Refrigeration” may refer to cooling items to be cold within a range in which the items are not frozen, and for example, the refrigerating chamber may be maintained within a range from 0 degrees Celsius to +7 degrees Celsius. “Freezing” may refer to cooling items to be frozen or maintained in a frozen state, and for example, the freezing chamber may be maintained within a range from minus 20 degrees Celsius to minus 1 degree Celsius. The variable temperature chamber may be used as either the refrigerating chamber or the freezing chamber based on a user selection or regardless of the user selection. FIG. 1 illustrates a case in which the storage chamber 102 is used as the refrigerating chamber. However, the storage chamber 102 is not limited thereto, and may be used as the freezing chamber or the variable temperature chamber. Meanwhile, the storage chamber 102 may be referred to by various names such as a “vegetable chamber,” a “fresh chamber,” a “cooling chamber,” or an “ice making chamber,” in addition to the name of the refrigerating chamber, the freezing chamber, or the variable temperature chamber.

When the storage chamber 102 is used as the refrigerating chamber, an internal temperature thereof may be maintained within a range from 0 degrees Celsius to +7 degrees Celsius. Accordingly, an external surface of a component that partitions the storage chamber 102 from the external environment and is in contact with external air may have a dew point lower than indoor air in homes, restaurants, or the like that are main places of use of the refrigerator 100, thereby causing dew condensation to occur on the surface.

According to an embodiment of the present disclosure, the main body 101 and the door 110 may each include an insulating material between the inner case and outer case thereof, thereby preventing dew condensation from occurring on the outer cases of the main body 101 and the door 110 due to a dew point different from that of external air.

In particular, the rotation bar 120 that seals a space between a first door 111 and a second door 112 may be disposed between the inside and outside of the storage chamber 102, thereby causing dew condensation to occur due to a temperature difference between the inside and the outside.

To prevent dew condensation from occurring on a surface of the rotation bar 120, the refrigerator 100 may increase a dew point of the surface of the rotation bar 120 by suctioning external air and delivering external air to the surface of the rotation bar 120 or by using a heater 160 that uses electrical energy. Accordingly, a product malfunction, a water accumulation around the door 110, or the like caused by dew condensation may be prevented.

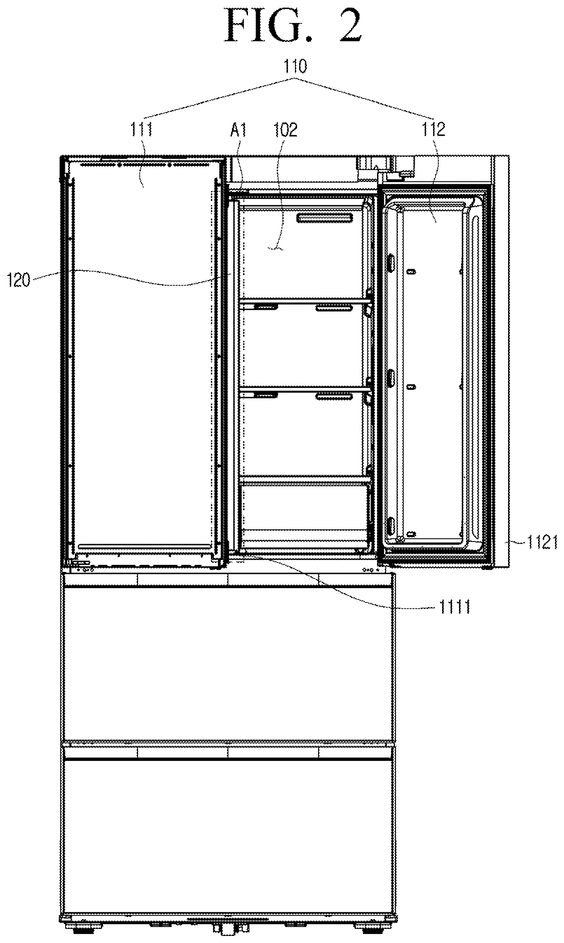

FIG. 2 is a view illustrating an operation of the rotation bar in a state in which the door is closed according to an embodiment of the present disclosure.

FIG. 2 illustrates a case in which the rotation bar 120 is formed on the first door 111 that is one of the plurality of doors 111 and 112. However, the rotation bar 120 is not necessarily limited thereto, and may be disposed on both the first and second doors 111 and 112.

When the first door 111 and the second door 112 close the storage chamber 102, the rotation bar 120 may serve to seal the space between the first door 111 and the second door 112. FIG. 2 illustrates a state in which the second door 112 is opened and the first door 111 is closed.

The rotation bar 120 may be connected through a hinge to a rear edge portion 1111 of the first door 111. The rotation bar 120 may rotate about the hinge. That is, the rotation bar 120 may be in a folded state toward a rear surface of the first door 111 at the rear edge portion 1111 of the first door 111, or may be rotated toward a front surface of the first door 111 and fixed in an unfolded state.

When the first door 111 on which the rotation bar 120 is disposed is closed, a protrusion formed on one side of the rotation bar 120 may come into contact with a guide member (not shown) that is disposed on the upper side or lower side of the storage chamber 102. As a force is applied in a direction in which the first door 111 is closed, the rotation bar 120 may slide while being in contact with the guide member to be unfolded, and as a result, the rotation bar 120 may seal the space between the first door 111 and the second door 112.

On the other hand, when the first door 111 is opened, the protrusion of the rotation bar 120 may be released from the guide member, and the rotation bar 120 may thus be folded toward the rear surface of the first door 111 and come into close contact therewith. Accordingly, when the first door 111 is in an opened state, the rotation bar 120 may have a plane parallel to an edge side of the first door 111.

As described above, when both the first and second doors 111 and 112 are closed, the rotation bar 120 may seal a space μl between the first door and the second door 111 and 112. Accordingly, cold air in the storage chamber 102 may be prevented from leaking outward from the main body 101, thereby maintaining a set temperature of the refrigerator 100 based on a usage of the storage chamber 102.

The top cover 130 is a component disposed on an upper side of the refrigerator 100 and capable of covering various components of the main body 101. For example, when the door 110 is hinge-coupled to the main body 101, the top cover 130 may cover a hinge disposed on an upper surface of the main body 101. In addition, components such as a sensor for measuring the temperature and humidity of external air may be disposed inside the top cover 130. In this way, the components disposed inside the top cover 130 may be easily accessible by separating only the top cover 130 from the main body 101 without disassembling the main body 101 of the refrigerator 100, thereby facilitating maintenance such as repair and replacement.

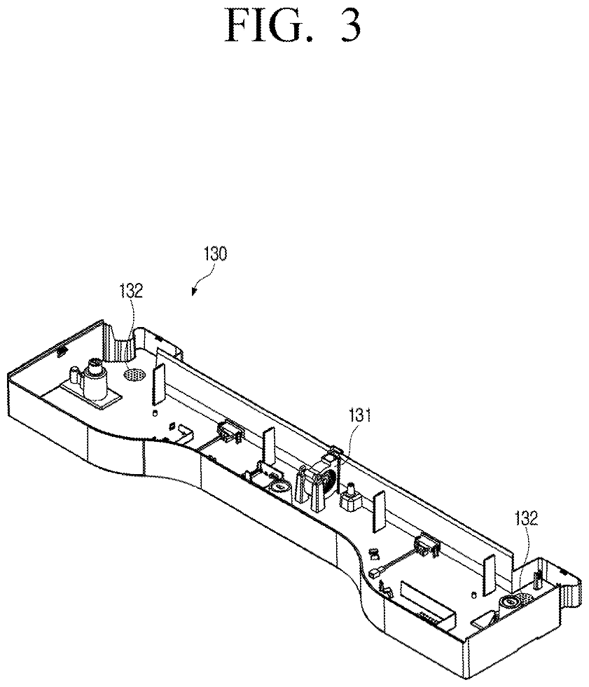

FIG. 3 is a rear perspective view of the top cover according to an embodiment of the present disclosure.

Specifically, referring to FIG. 3, the top cover 130 may have an open lower surface 1301 in contact with the main body 101.

The top cover 130 may include a fan 131 and a suction port 132.

The fan 131 is a component for suctioning external air by forming a pressure difference between internal air and external air of the top cover 130.

The suction port 132 may be implemented as an opening that allows the inner and outer spaces of the top cover 130 to communicate with each other to suction external air. For example, the suction port 132 may be configured to allow an internal space in the top cover 130 to be in communication with an environment outside of the top cover 130. FIG. 3 illustrates a case in which two suction ports 132 are provided, one on each of both sides of the top cover 130. However, the present disclosure is not limited thereto. For example, the top cover 130 may be implemented to include only one suction port 132 disposed around the fan 131. Although not separately illustrated in FIG. 3, components such as a motor for rotating the fan 131 or a sensor for measuring the temperature or humidity of external air may further be disposed inside the top cover 130.

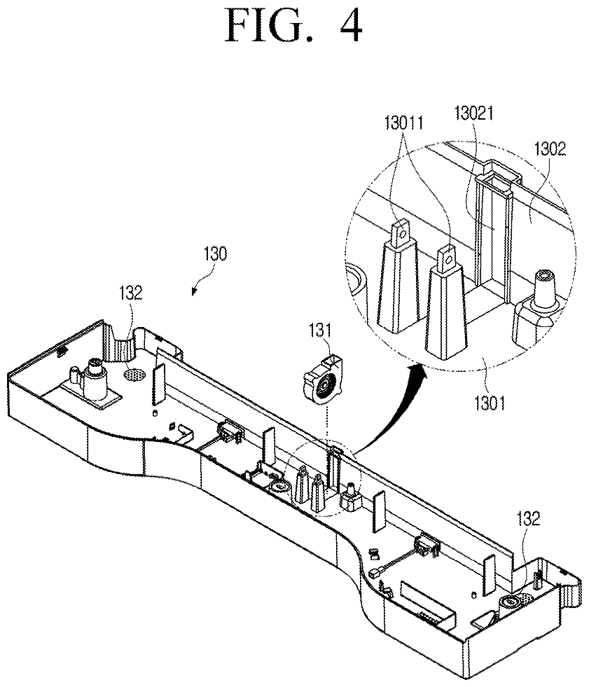

FIG. 4 is a view illustrating a portion in which the fan is fixed to the top cover according to an embodiment of the present disclosure.

Referring to FIG. 4, the fan 131 may be coupled to an upper surface 1301 of the top cover 130 to be disposed between the top cover 130 and the main body 101.

A pair of bridges 13011 may be formed on the upper surface 1301 of the top cover 130 to allow the fan 131 to be coupled thereto. A groove 13021 may be formed on a side surface 1302 of the top cover 130 adjacent to the door 110 to allow the fan 131 to be coupled thereto. The fan 131 may have one side fixed to the bridge 13011 of the upper surface 1301 of the top cover 130 and the other side fixed to the groove 13021.

Accordingly, the fan 131 may be stably fixed to the upper surface 1301 of the top cover 130, thereby minimizing vibration and noise occurring due to an operation of the fan 131, and preventing the fan 131 from deviating from an initially fixed position thereof during the operation of the fan 131.

The fan 131 may be disposed on the top cover 130, thereby preventing vibration and noise occurring due to the operation of the fan 131 from being transmitted to the main body 101. In addition, when the motor or rotating blades of the fan 131 are damaged, maintenance thereof may be facilitated.

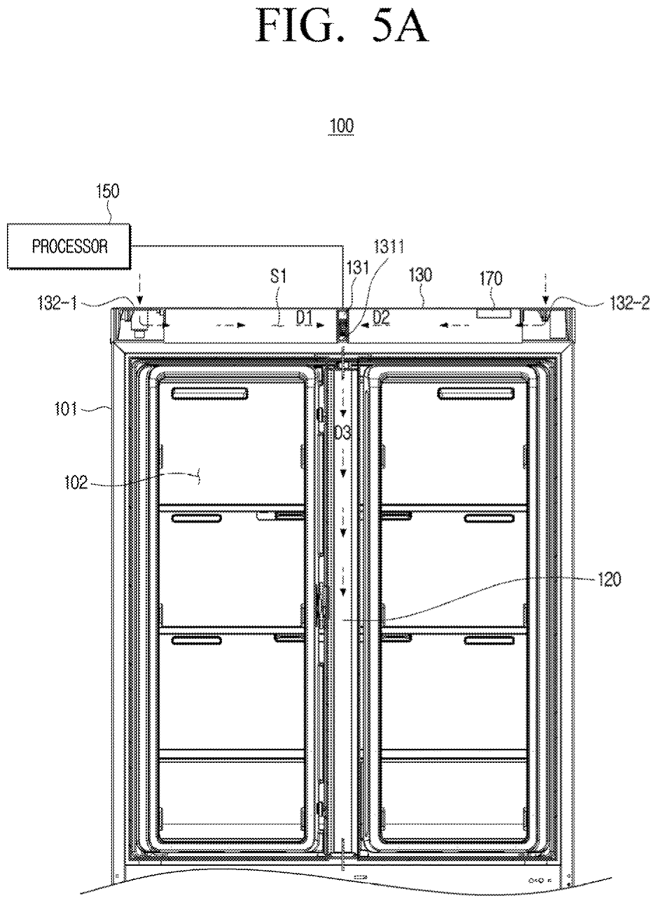

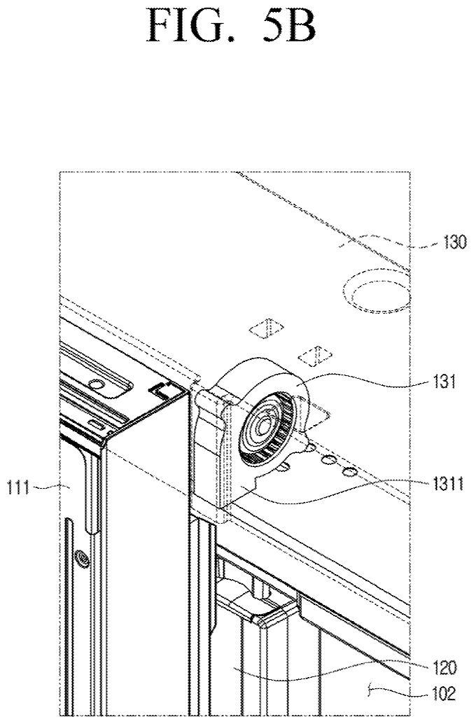

Air suctioned from the top cover 130 by the fan 131 may be blown toward the rotation bar 120 disposed between the first door and the second door 111 and 112. To this end, the fan 131 may be disposed adjacent to the rotation bar 120. For example, the fan 131 may be disposed to face one end of the rotation bar 120 (see FIG. 5B).

FIG. 5A is a cross-sectional view of the refrigerator in which the top cover is disposed according to an embodiment of the present disclosure. Specifically, FIG. 5A is a cross-sectional view taken along line A-A′ of the refrigerator illustrated in FIG. 1. FIG. 5B is an enlarged view illustrating a specific arrangement of the fan according to an embodiment of the present disclosure.

Referring to FIGS. 5A and 5B, the refrigerator 100 may further include a processor 150. The processor 150 is a component for controlling an operation of the refrigerator 100. The processor 150 may be mounted on a main board of the refrigerator 100. However, the processor 150 is not necessarily limited thereto, and may be implemented as a control circuit further mounted on the main body 101, the door 110, the top cover 130, or the like. The processor 150 may drive the fan 131 to introduce external air. Although a specific illustration is omitted from FIGS. 5A and 5B, a power supply circuit, a motor, and the like for driving the fan 131 may further be provided.

Meanwhile, the fan 131 may be disposed at a center of a top cover 130 to face one end of the rotation bar 120.

More specifically, in a state in which the door 110 is closed, the center of the top cover 130 may correspond to an upper end of the rotation bar 120. As a result, the fan 131 may be disposed inside the top cover 130 to face one end of the rotation bar 120.

When the fan 131 is operated by the processor 150, external air may be introduced from an outside of the top cover 130 into an inside S1 of the top cover 130 through the suction port 132. A discharge port 1311 for discharging air suctioned by the fan 131 may be disposed to face the rotation bar 120.

Accordingly, air may flow toward the rotation bar 120 due to driving of the fan 131, thereby preventing dew condensation caused by a temperature difference between the inside and the outside.

According to a rotation speed of the fan 131, the air flow velocity and air flow rate of external air delivered to the rotation bar 120 may be adjusted. For example, when the rotation speed of the fan 131 is high, the air flow velocity and air flow rate of external air delivered to the rotation bar 120 may increase. On the other hand, when the rotation speed of the fan 131 is low, the air flow velocity and air flow rate of external air delivered to the rotation bar 120 may decrease.

As described above, at least one sensor may be included in the top cover 130. FIG. 5A illustrates a case in which a sensor 170 for sensing at least one of the temperature or humidity of external air is included.

Dew condensation refers to a phenomenon in which moisture in air is condensed. Specifically, in an environment in which air contains a large amount of moisture, when the surface or internal temperature of a certain portion becomes a dew-point temperature that is lower than an atmospheric temperature, dew condensation may occur on the portion. Therefore, when a surface temperature of the rotation bar 120 is lower than a dew-point temperature corresponding to an external air temperature, dew condensation may occur on the rotation bar 120. When the temperature or humidity of external air is identified based on a sensing value obtained from the sensor 170, the processor 150 may identify the dew-point temperature corresponding to the temperature or humidity of external air, compare the dew-point temperature with the internal temperature of the storage chamber 102 or the surface temperature of the rotation bar 120, and diagnose the possibility of occurrence of dew condensation. When the processor 150 diagnoses that dew condensation occurs on the surface of the rotation bar 120 or diagnoses a state in which the possibility of occurrence of dew condensation is high, the processor 150 may control the rotation speed of the fan 131.

In a general situation, the processor 150 may not drive the fan 131, and when the state described above is identified based on the sensing value obtained from the sensor 170, the processor 150 may drive the fan 131. In some embodiments, in a state in which the processor 150 continuously drives the fan 131, when the state described above is identified based on the sensing value obtained from the sensor 170, the processor 150 may increase the rotation speed of the fan 131.

When the sensor 170 includes a humidity sensor, the processor 150 may classify humidity modes as shown in the following table based on an output value from the humidity sensor.

TABLE 1

| | Humidity mode | | | | | | | | | | | | |
|---|---|---|---|---|---|---|---|---|---|---|---|---|---|
| | 0 | 1 | 2 | 3 | 4 | 5 | 6 | 7 | 8 | 9 | 10 | 11 | 12 |
| Humidity (%) | 0~10 | 11~23 | 24~36 | 37~49 | 50~59 | 60~64 | 65~69 | 70~76 | 77~81 | 82~84 | 85~89 | 90~94 | 95~100 |

Meanwhile, data summarized in Table 1 may be stored in a memory 140. The processor 150 may obtain the sensing value from the sensor 170 a total of 40 times in a cycle of every 20 minutes, and may calculate an average value. In this case, a maximum value and a minimum value may be excluded. When the average value is sensed, the processor 150 may identify a humidity mode corresponding to the average value. Based on the identified humidity mode, the processor 150 may determine whether to operate the fan 131 and a rotation speed thereof (hereinafter, referred to as a fan operation rate), and drive the fan 131.

While driving the fan 131, the processor 150 may determine humidity again by using the sensor 170. When humidity is identified again, the processor 150 may identify a humidity mode corresponding to the identified humidity again, and may drive the fan 131 accordingly.

Meanwhile, in an initial state in which the refrigerator 100 is powered on, or when the refrigerator 100 is reset, a sensing value obtained from the sensor 170 may not be accumulated and determined. In this case, the processor 150 may determine the humidity mode as an arbitrary mode and may drive the fan 131 according to a fan operation rate corresponding to the mode. For example, when humidity mode 7 of Table 1 is set as a default, the processor 150 may drive the fan 131 at a fan operation rate of about 70 to 76%. Information on a default humidity mode may be prestored in the memory 140. In addition, information on the fan operation rate for each humidity mode may be prestored in the memory 140. Specifically, the fan operation rate for each humidity mode may be summarized as shown in the following table.

TABLE 2

| External air | Humidity mode | | | | | | | | | | | | |
|---|---|---|---|---|---|---|---|---|---|---|---|---|---|
| temperature | 0 | 1 | 2 | 3 | 4 | 5 | 6 | 7 | 8 | 9 | 10 | 11 | 12 |
| 34° C. | 0% | 5% | 25% | 40% | 50% | 55% | 65% | 70% | 90% | 100% | 100% | 100% | 100% |
| or higher | | | | | | | | | | | | | |
| 28~33° C. | 0% | 0% | 10% | 25% | 35% | 40% | 50% | 60% | 70% | 80% | 85% | 95% | 100% |
| 27° C. | 0% | 0% | 5% | 15% | 30% | 35% | 40% | 45% | 60% | 75% | 75% | 85% | 90% |
| or lower | | | | | | | | | | | | | |

Based on a temperature setting of the storage chamber 102, an external air temperature, and a humidity sensor value, the processor 150 may drive the fan 131 at the fan operation rate as shown in Table 2 described above. At an initial driving time or a re-driving time after reset, the processor 150 may drive the fan 131 based on a default condition, and may measure humidity and temperature in units of a predetermined time cycle and drive the fan 131 based on Table 2 described above. Meanwhile, in a case in which the refrigerator 100 includes an energy saver function for energy saving, when the energy saver function is activated, the processor 150 may drive the fan 131 at a fan operation rate reduced by 5% based on Table 2. When the refrigerator 100 is abnormally powered on, the processor 150 may stop the operation of the fan 131 for a predetermined time.

In addition to driving the fan 131 based on a temperature and humidity detection result obtained from the sensor 170, the processor 150 may be implemented to drive the fan 131 at each predetermined cycle regardless of the sensing value. In some embodiments, when a user selects a dew condensation prevention function, the processor 150 may drive the fan 131.

When external air blows toward the rotation bar 120 due to driving of the fan 131, a dew point of the surface of the rotation bar 120 may increase to a level that is identical or similar to that of external air, and as a result, dew condensation may be solved.

The fan 131 may be implemented as a blow fan, is not limited thereto, and may include various types of fans 131. The blow fan refers to a fan including a discharge port that sets an air flow direction of discharged air. Specifically, in the blow fan, a direction of the discharge port may be perpendicular to an axis about which rotating blades rotate. Accordingly, the fan 131 may guide the air flow direction to blow external air having air flow directions in first and second directions D1 and D2 introduced from a plurality of suction ports 132-1 and 132-2 of the top cover 130 in a third direction D3 toward the rotation bar 120.

The suction port 132 is a component for allowing the inner space S1 of the top cover 130 and the outside to communicate with each other to introduce external air into the inner space S1 of the top cover 130. Although two suction ports 132-1 and 132-2 are illustrated in the drawing, the number of suction ports 132 is not limited thereto and may be implemented as a singular suction port or a plurality of suction ports, the plurality of suction ports including three or more suction ports, as necessary.

Meanwhile, external air may be heated by heat occurring in the main body 101 while passing through the inner space S1 of the top cover 130.

As external air is introduced toward the rotation bar 120 by the fan 131, air having a temperature identical to or higher than that of external air may continuously come into contact with an outer surface 1201 of the rotation bar 120 that is in contact with external air, thereby increasing a dew point of the outer surface 1201 of the rotation bar 120, which is decreased due to cold air in the storage chamber 102. The dew point of the outer surface 1201 of the rotation bar 120 may become identical to or higher than that of external air in contact with the outer surface 1201, thereby preventing dew condensation from occurring on the outer surface 1201 of the rotation bar 120.

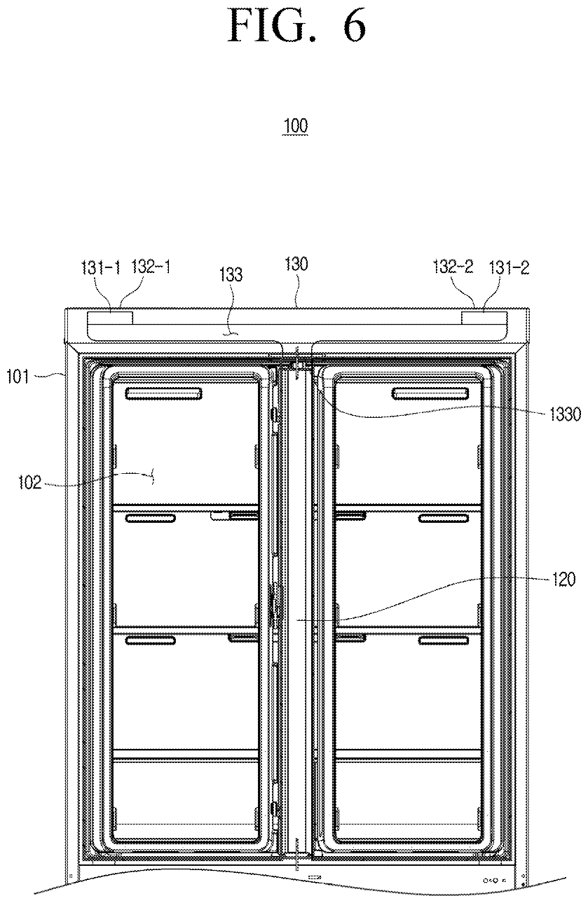

FIG. 6 is a cross-sectional view illustrating an internal configuration of the top cover according to another embodiment of the present disclosure.

Referring to FIG. 6, the fan 131 may include the plurality of fans 131-1 and 131-2. Although two fans 131-1 and 131-2 are illustrated in the drawing, the number of fans 131 may be implemented as a plurality of fans 131-n, the plurality of fans 131-n including three or more fans, as necessary. Hereinafter, the description describes the top cover 130 including two fans 131-1 and 131-2.

The two fans 131-1 and 131-2 may be disposed symmetrically on both sides of the center of the top cover 130. Two suction ports 132-1 and 132-2 corresponding thereto may be formed on an upper surface of the top cover 130 on which the two fans 131-1 and 131-2 are disposed.

In this way, by disposing the plurality of fans 131-n and the plurality of suction ports 132-n symmetrically on both the sides of the center of the top cover 130, an identical amount of external air may be introduced to both sides of the top cover 130.

Accordingly, performance degradation or malfunction of the fan 131 occurring due to unbalanced introduction of external air may be prevented. In addition, degradation of a coupling force with the main body 101 may be prevented by preventing a movement of the top cover 130 occurring due to the unbalanced introduction of external air.

Meanwhile, an air flow path 133 connected to each of the plurality of fans 131-n and guiding a flow of external air introduced into the top cover 130 may be formed inside the top cover 130.

The air flow path 133 is a component for guiding external air introduced toward the rotation bar 120 to prevent a problem such as backflow occurring during a process of mixing external air introduced into the plurality of suction ports 132-n by the plurality of fans 131-n inside the top cover 130.

The air flow path 133 may efficiently maintain a pressure difference from that of external air occurring due to driving of the fan 131 by limiting a space in which external air is able to occupy inside the top cover 130. In addition, the air flow path 133 may minimize decrease in an air flow velocity in a process in which introduced external air is delivered to the rotation bar 120 by preventing external air from being introduced into a space in which the flow of external air may stagnate inside the top cover 130.

The air flow path 133 may include a blowing port 1330. The blowing port 1330 is a component for delivering external air suctioned through the suction port 132 and passing through the air flow path 133 toward the rotation bar 120. According to Bernoulli's principle, as an area of a flow path becomes smaller, a speed of a fluid passing through the flow path may increase. Accordingly, an area of the blowing port 1330 may be designed in consideration of a speed of an air flow blown by the fan 131 based on a length of the rotation bar 120.

For example, when the rotation bar 120 has a first length, the blowing port 1330 may be designed as a first area to allow blown air flow to have a first speed, and when the rotation bar 120 has a second length greater than the first length, the blowing port 1330 may be designed as a second area narrower than the first area to allow blown air flow to have a second speed greater than the first speed.

As the fan 131 is driven, a pressure in the inner space S1 of the top cover 130 may become lower than a pressure in the outer space of the top cover 130, thereby introducing external air into the air flow path 133 through the suction port 132, and delivering introduced external air toward the rotation bar 120 in a state in which the door 110 is closed through the blowing port 1330.

Meanwhile, the processor 150 may independently drive the plurality of fans 131-n based on surrounding environment information detected by the sensor 170. For example, when a temperature difference between the surface temperature of the rotation bar 120 and an external air temperature is slight, dew condensation may occur extremely rarely on the surface of the rotation bar 120, and in such a case, the processor 150 may drive only some fans 131 among the plurality of fans 131-n.

Accordingly, an amount of external air introduced into the top cover 130 may be sharply reduced, and power consumed to operate the fan 131 may also be saved.

Meanwhile, when the processor 150 drives all of the plurality of fans 131-n, the plurality of fans 131-n may rotate at an identical speed. Accordingly, malfunction of the fan 131 occurring due to the unbalanced introduction of external air and the movement of the top cover 130 may be prevented. However, a method of controlling driving of each of the plurality of fans 131-n is not limited thereto, and different methods of driving the plurality of fans 131-n may be provided as necessary.

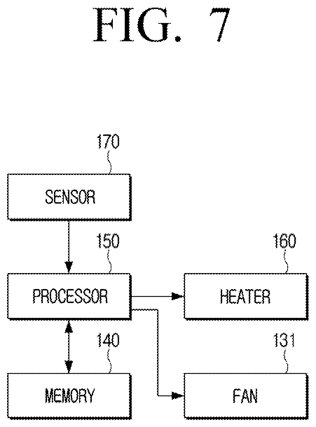

FIG. 7 is a block diagram illustrating driving of the fan and heater of the refrigerator according to still another embodiment of the present disclosure. Referring to FIG. 7, the refrigerator 100 may include the memory 140, the processor 150, the heater 160, and the sensor 170.

The heater 160 is a component disposed in the refrigerator 100 for preventing dew condensation. The heater 160 may be disposed inside the rotation bar 120. However, the heater 160 is not necessarily limited thereto and may be disposed in a door region around the rotation bar 120.

The memory 140 is a component for storing various information, data, instructions, programs, or the like necessary for operation of the refrigerator 100. The memory 140 may store temporary data generated during a process of generating a control signal for controlling components included in the refrigerator 100. The memory 140 may be implemented as at least one of a volatile memory (e.g., a dynamic random access memory (DRAM), a static random access memory (SRAM), or a synchronous dynamic random access memory (SDRAM)), or a non-volatile memory (e.g., a one time programmable read only memory (OTPROM), a programmable read only memory (PROM), an erasable and programmable read only memory (EPROM), an electrically erasable and programmable read only memory (EEPROM), a mask read only memory (mask ROM), a flash read only memory (a flash ROM), a flash memory (e.g., a NAND flash or a NOR flash), a hard drive, or a solid state drive (SSD)).

Specifically, the memory 140 may store surrounding environment information corresponding to conditions for driving the fan 131 and/or the heater 160. For example, the memory 140 may store information on the internal temperature of the storage chamber 102, a temperature of the outer surface 1201 of the rotation bar 120, and the external air temperature.

In addition, the memory 140 may store various reference values for determining whether to drive the fan 131, for example, information on a threshold value of a temperature difference between the internal and external temperatures of the storage chamber 102, the external temperature, external humidity, or the like.

The memory 140 may store information on methods of driving the fan 131 and the heater 160. For example, the memory 140 may store information on a rotation speed of the fan 131 corresponding to each level by classifying a speed of an air flow generated by the fan 131 into high, medium, and low. Similarly, the memory 140 may store information on an output of the heater 160 corresponding to each level by classifying an amount of heat generated by the heater 160 into high, medium, and low. A detailed description of the heater 160 is provided below.

The processor 150 is a component for controlling an overall operation of the refrigerator 100. The processor 150 may control components included in the refrigerator 100 based on volatile or non-volatile information stored in the memory 140. The processor 150 may generate a control signal for controlling the fan 131 or the heater 160. The processor 150 may include at least one of a digital signal processor (DSP) for processing a digital image signal, a microprocessor, a neural processing unit (NPU), a central processing unit (CPU), a micro controller unit (MCU), or an application processor (AP), or may be defined by such a term. In addition, the processor 150 may be implemented as a system-on-chip (SoC) in which a processing algorithm is embedded or a large scale integration (LSI), and may be implemented as an application specific integrated circuit (ASIC) or a field programmable gate array (FPGA).

For example, the processor 150 may store, in the memory 140, surrounding environment information such as a temperature or humidity measured based on the sensing value obtained from the sensor 170. In addition, the processor 150 may compare a reference value stored in the memory 140 with surrounding environment information to determine whether to drive the fan 131 or the heater 160, and may generate a control signal for controlling the fan 131 and/or the heater 160. The control signal generated by the processor 150 may be transmitted to the fan 131 and/or the heater 160, thereby adjusting whether to operate and an operation intensity. Specifically, the processor 150 may drive the fan 131 to introduce external air or may drive the heater 160 to provide heat to the rotation bar 120.

As described above, the processor 150 may identify a humidity mode based on the sensing value obtained from the sensor 170 and may drive the fan 131 at various fan operation rates based on the humidity mode and various surrounding environment information. The processor 150 may drive the heater 160 in various manners based on the humidity mode and the external air temperature. Specifically, the processor 150 may increase an intensity of the heater 160 as the humidity mode becomes higher. In some embodiments, when the heater 160 is segmented into a plurality of regions and individual driving is possible for each region, the processor 150 may control driving of the heater for each region based on the humidity mode. This configuration is described again in the following description.

The description above describes an embodiment in which the processor 150 automatically controls the fan 131 and the heater 160 based on the information stored in the memory 140 and the sensing value measured by the sensor 170. However, the fan 131 and the heater 160 may be directly manipulated by the user as necessary.

For example, the processor 150 may control operations of the fan 131 and the heater 160 based on a value input by the user through a user interface. In this case, the refrigerator 100 may include an interface in the main body 101 or the door 110, and the user interface may be provided using an input interface and an output interface. In addition, the processor 150 may transmit a display control signal and image data to the user interface to display an image on the interface in response to a user input. The input interface may include a key, a touch screen, a microphone, or the like, and the output interface may include a display, a speaker, or the like.

Meanwhile, the memory 140 and the processor 150 may be provided integrally or may be provided separately. The processor 150 may include at least one processor. For example, the processor 150 may include a main processor and at least one sub processor. The memory 140 may include at least one memory.

Although FIG. 7 illustrates three heaters 160 and one fan 131, a plurality of fans and a plurality of heaters may each be implemented.

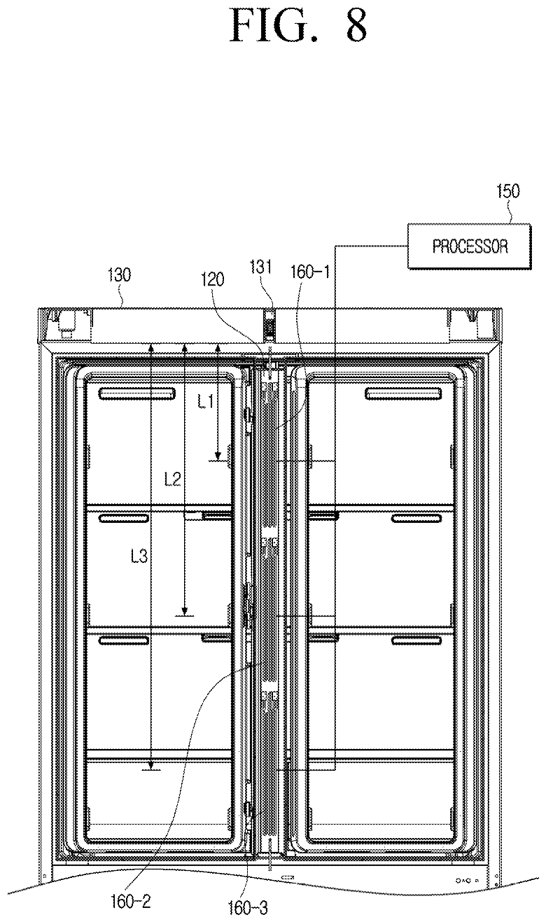

FIG. 8 is a view illustrating arrangement of the heater of the rotation bar according to an embodiment of the present disclosure. Referring to FIG. 8, the rotation bar 120 may include the heater 160.

The heater 160 is a component for preventing dew condensation from occurring on the surface of the rotation bar 120 by increasing the surface temperature of the rotation bar 120 to maintain a dew point of the outer surface 1201 of the rotation bar 120 that is in contact with external air at a level that is identical to or higher than external air.

The heater 160 may be an electric heater, and may receive electricity from a power source of the refrigerator 100 and convert electrical energy into thermal energy.

The heater 160 may be embedded inside the rotation bar 120, and a component such as a wire for supplying electricity to the heater 160 may be included in the door 110. In some embodiments, the heater 160 may be disposed adjacent to the surface of the rotation bar 120 that is in contact with external air. The inside of the rotation bar 120 may be formed of a material having thermal insulation performance or heat resistance performance. Accordingly, heat generated by the heater 160 may be prevented from increasing the internal temperature of the storage chamber 102.

The heater 160 may be disposed along a length direction of the rotation bar 120 and may be segmented into a plurality of regions 160-n. In the drawings, the heater 160 is illustrated as being segmented into three regions 160-1, 160-2, and 160-3, the present disclosure is not limited thereto, and the heater 160 may be segmented into a single region or a plurality of regions other than three as necessary. Hereinafter, the description describes an embodiment in which the heater 160 is segmented into three regions 160-1, 160-2, and 160-3.

The regions 160-1, 160-2, and 160-3 of the heater 160 may each be independently driven. For example, when the first region 160-1 of the heater 160 is driven, the second region 160-2 or the third region 160-3 may not be driven, and only the first and second regions 160-1 and 160-2 of the heater 160 may be driven and the third region 160-3 may not be driven.

In some embodiments, the heaters 160 of the respective regions 160-1, 160-2, and 160-3 may be formed as different types of heaters. For example, the heater of the first region 160-1 may be the heater 160 having a lower output than the heater of the second region 160-2, and the heater of the third region 160-3 may be the heater 160 having a higher output than the heater of the second region 160-2.

Meanwhile, the processor 150 may individually adjust an intensity of each of the regions 160-1, 160-2, and 160-3 of the heater 160 based on a vertical distance L1, L2, or L3 between the top cover 130 and a corresponding one of the regions 160-1, 160-2, and 160-3. For example, the first region 160-1 having the vertical distance corresponding to the first distance L1 from the top cover 130 may be heated to a lower temperature than the second region 160-2 having the second distance L2 farther than the first distance L1. The third region 160-3 having the third distance L3 farthest from the top cover 130 may be heated to a higher temperature than the second region 160-2.

When the heater 160 is segmented into the plurality of regions 160-1, 160-2, and 160-3 as described with reference to FIG. 8, the processor 150 may drive the heater 160 based on operation mode information as shown in the following table.

TABLE 3

| External air | Humidity mode | | | | | | | | | | | | |
|---|---|---|---|---|---|---|---|---|---|---|---|---|---|
| temperature | 0 | 1 | 2 | 3 | 4 | 5 | 6 | 7 | 8 | 9 | 10 | 11 | 12 |
| 34° C. | Case3 | Case3 | Case3 | Case3 | Case2 | Case2 | Case2 | Case2 | Case1 | Case1 | Case1 | Case1 | Case1 |
| or higher | | | | | | | | | | | | | |
| 28~33° C. | Case3 | Case3 | Case3 | Case2 | Case2 | Case2 | Case2 | Case1 | Case1 | Case1 | Case1 | Case1 | Case1 |
| 27° C. | Case3 | Case3 | Case2 | Case2 | Case2 | Case2 | Case1 | Case1 | Case1 | Case1 | Case1 | Case1 | Case1 |
| or lower | | | | | | | | | | | | | |

In Table 3, Case 1 refers to driving the lower heater region 160-3 among the plurality of regions 160-1, 160-2, and 160-3; Case 2 refers to driving the middle and lower heater regions 160-2 and 160-3 among the plurality of regions 160-1, 160-2, and 160-3; and Case 3 refers to driving all of the plurality of regions 160-1, 160-2, and 160-3. When a “power refrigeration” function or a “power freezing” function is set, the processor 150 may not drive the heater 160 for a predetermined time. Accordingly, when the function is set, a temperature of the storage chamber 102 may be lowered within a short time.

Meanwhile, even when an amount of external air delivered to a lower region of the rotation bar 120 decreases as a distance from the top cover 130 increases in the length direction of the rotation bar 120, dew condensation occurring on a lower portion of the rotation bar 120 may be prevented using the heater 160.

In this way, the surface of the rotation bar 120 may be individually heated by the plurality of regions 160-n of the heater 160, and a dew point of the surface of the rotation bar 120 may become identical to or higher than that of external air, thereby preventing dew condensation from occurring on the surface of the rotation bar 120.

In addition, waste of electricity may be prevented by heating the outer surface 1201 of the rotation bar 120, a dew point of which already identical to or higher than that of external air due to external air delivered from the fan 131.

As described above, the processor 150 may selectively drive the fan 131 and the heater 160 based on the sensing value obtained from the sensor 170. The processor 150 may alternately drive the fan 131 and the heater 160.

Such an operation method is merely an example and is not limited thereto. According to another embodiment, the fan 131 and the heater 160 may be continuously driven and intensities thereof may be selectively adjusted.

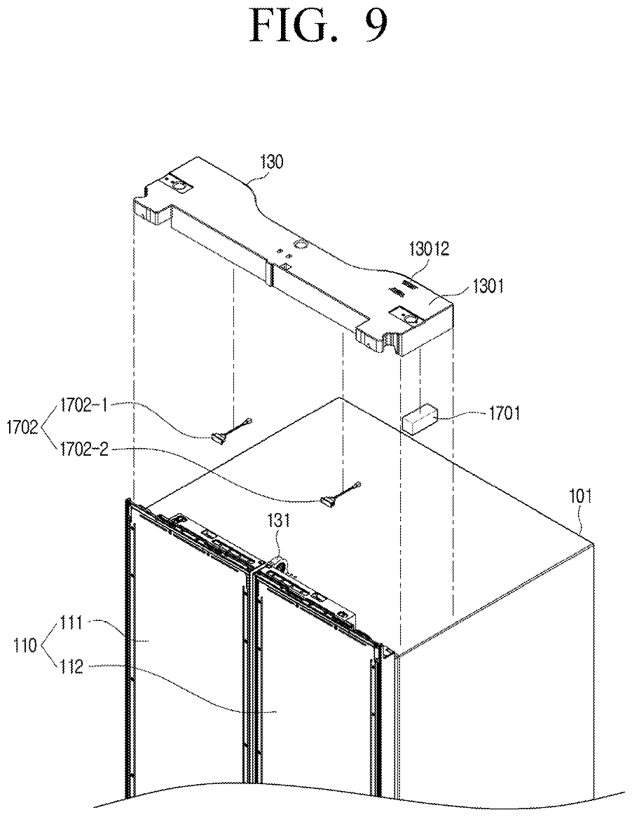

FIG. 9 is a view illustrating the sensor according to an embodiment of the present disclosure. Referring to FIG. 9, the sensor 170 disposed on the top cover 130 may include a sensor 1701 for measuring at least one of temperature or humidity and a sensor 1702 for detecting the opening or closing of the door 110.

The sensor 1701 for measuring temperature and/or humidity may measure the temperature and/or humidity of external air. The sensor 1701 for measuring temperature and/or humidity may be coupled to the upper surface 1301 of the top cover 130. In this case, to allow the sensor 1701 to sense information on external air, an opening 13012 may be formed in the upper surface 1301 on which the sensor 1701 is attached to communicate with the external environment. The opening 13012 may have a shape in which a plurality of holes are punched. The opening 13012 may be formed in an area smaller than an area in which the sensor 1701 is in contact with the upper surface 1301 of the top cover 130 to prevent the opening 13012 from disturbing an airflow of external air introduced through the suction port 132.

A door sensor 1702 for detecting the opening or closing of the door 110 may include a plurality of door sensors 1702-n corresponding to the number of doors 110. In the drawing, two doors 110-1 and 110-2 and two door sensors 1702-1 and 1702-2 corresponding thereto are illustrated, and the present disclosure is not limited thereto.

The door sensor 1702 may generate different electrical signals based on whether the door 110 is opened or closed. The electrical signal generated by the door sensor 1702 may be transmitted to the processor 150, and the processor 150 may determine whether to drive the fan 131 based thereon. For example, when both the two doors 110-1 and 110-2 are opened, the two door sensors 1702-1 and 1702-2 may generate corresponding electrical signals. The processor 150 may determine that all the doors 110 of the refrigerator 100 are opened and stop driving the fan 131 or maintain a non-driven state of the fan. When one door 110-1 of two doors 110-1 and 110-2 is opened, the door sensor 1702-1 that detects the opening or closing of the opened door 110-1 and the door sensor 1702-2 that detects the opening or closing of the closed door 110-2 may generate different electrical signals. When electrical signals received from the two door sensors 1702-1 and 1702-2 have different values, the processor 150 may stop driving the fan 131 or maintain the non-driven state. In contrast, when both the two door sensors 1702-1 and 1702-2 transmit electrical signals corresponding to a state in which the door 110 is closed, the processor 150 may drive the fan 131.

In this way, the fan 131 may be operated only when all the doors 110 are detected by the door sensor 1702 to be in a closed state, thereby preventing external air from being introduced into the storage chamber 102 due to driving of the fan 131 while any of the doors 110 is opened.

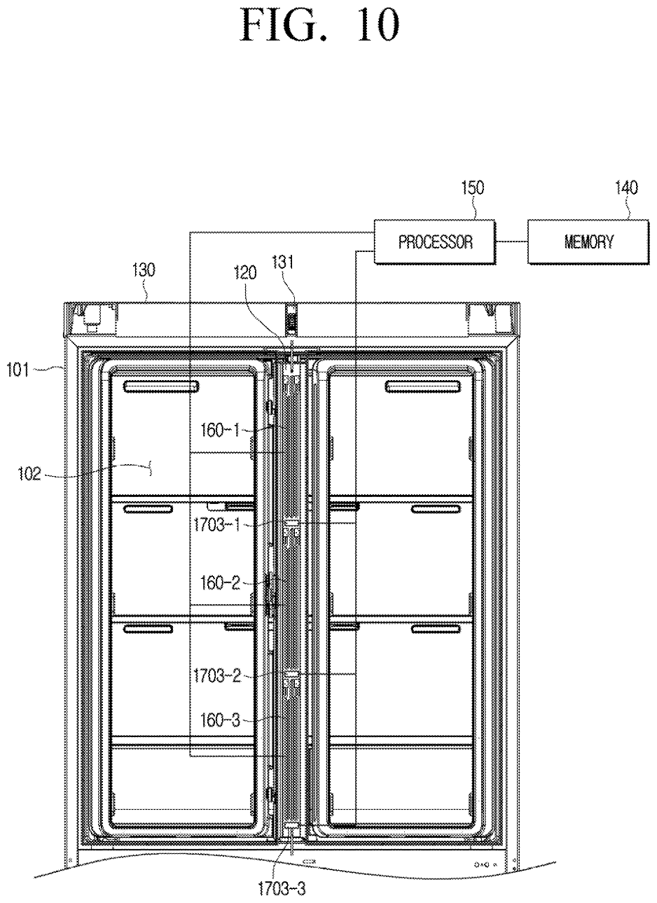

FIG. 10 is a view illustrating that the sensor is embedded in the rotation bar according to another embodiment of the present disclosure. Referring to FIG. 10, the sensor 170 may further include at least one sensor 1703 disposed in the rotation bar 120.

Specifically, sensors 1703-1, 1703-2, and 1703-3 for measuring at least one of temperature or humidity may be distributed and disposed on the rotation bar 120.

Although FIG. 10 illustrates three sensors 1703-1, 1703-2, and 1703-3, each disposed for each of three heater regions 160-1, 160-2, and 160-3, the number and arrangement thereof are not limited thereto.

The sensors 1703-1, 1703-2, and 1703-3 embedded in the rotation bar 120 may measure the temperature and/or humidity of the surface of the rotation bar 120 and external air around the surface of the rotation bar 120, convert such sensing values into corresponding electrical signals, and transmit the electrical signals to the processor 150.

The processor 150 may individually adjust an intensity of each of the regions 160-1, 160-2, and 160-3 of the heater of the rotation bar 120 based on the sensing values respectively measured by the plurality of sensors 1703-1, 1703-2, and 1703-3.

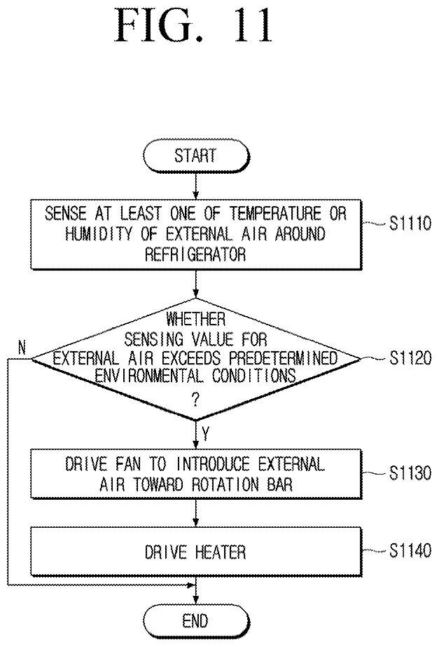

FIG. 11 is a flowchart illustrating a method for preventing dew condensation in a refrigerator according to an embodiment of the present disclosure. Referring to FIG. 11, the sensor included in the refrigerator may sense the temperature or humidity of external air around the refrigerator (S1110).

The fan disposed on the top cover may be driven to introduce external air toward the rotation bar that seals the space between the first door and second door of the refrigerator (S1130) when the sensed temperature or humidity of external air around the refrigerator deviates from predetermined environment conditions (S1120).

The environment conditions may correspond to range conditions in which temperature or humidity is at a level at which dew condensation does not occur. For example, the fan may not be driven when the temperature difference between the surface temperature of the rotation bar and the external air temperature is within a first range. In contrast, the fan may be driven to introduce external air toward the rotation bar when the temperature difference between the surface temperature of the rotation bar and the external air temperature is within a second range that is greater than the first range. Here, the first range and the second range may be set in a process of manufacturing the refrigerator or in a process of inputting data for controlling the refrigerator after manufacturing. The first range and the second range may be differently set based on a region in which the refrigerator is used. For example, different ranges may be set and stored for a refrigerator used in a country in which temperature and humidity are basically high and a refrigerator used in a country in which temperature and humidity are low.

When the refrigerator determines that the sensed surrounding environment information deviates from the predetermined environment conditions, the refrigerator may drive not only the fan but also the heater included in the rotation bar. Accordingly, dew condensation may be prevented from occurring on the rotation bar (S1140). The driving of the heater included in the rotation bar may be performed when dew condensation still occurs on the rotation bar even though the driving of the fan to introduce external air is already performed.

Whether dew condensation occurs on the rotation bar may be determined based on the sensing value obtained from the sensor. The sensor may be disposed inside the top cover, or may be disposed on the rotation bar. The sensor may include at least one sensor.

Meanwhile, the heater may be disposed along the length direction of the rotation bar and may be segmented into the plurality of regions.

The preventing of the dew condensation from occurring on the rotation bar by driving the heater may include independently driving each of the plurality of regions of the heater to allow an intensity of the heater to increase in proportion to the vertical distance between the top cover and each of the plurality of regions of the heater.

For example, when the regions of the heater in the rotation bar are segmented into the first region, the second region, and the third region in an order of a shorter vertical distance between the fan and the heater, an intensity of the heater may increase in an order from the first region to the third region. Information on a distance between the fan and the first region, the second region, or the third region may be stored as non-volatile data in the memory.

Meanwhile, the preventing of the dew condensation occurring on the rotation bar by driving the heater may include identifying the sensing values obtained from the sensors respectively disposed in the plurality of regions of the heater and adjusting an intensity of each of the plurality of regions of the heater based on the sensing values.

For example, when the region of the heater is segmented into the first region to the third region, the sensor may be disposed at a position corresponding to each region of the plurality of heaters. The plurality of sensors may sense information on the surface of the rotation bar and the surrounding environment at positions at which the plurality of heaters are disposed. When the sensing value measured by the sensor disposed in the upper heater region 160-1 is a value determined as indicating that dew condensation occurs, and the sensing values measured by the sensors disposed in the remaining heater regions 160-2 and 160-3 are values determined as indicating that dew condensation does not occur, the processor may drive only the upper heater region 160-1. Accordingly, the heaters of the second region and the third region in which dew condensation does not occur are not driven, thereby reducing power consumption.

As described above, according to the embodiments of the present disclosure, the refrigerator 100 capable of preventing dew condensation may prevent dew condensation from occurring on the surface of the rotation bar 120 by driving the fan 131 disposed on the top cover 130 to introduce external air into the top cover 130 and then delivering external air toward the rotation bar 120, or by driving the heater 160 disposed on the rotation bar 120 to generate heat. Driving of each of the fan 131 and the heater 160 may be independently performed, and may be controlled by the processor 150 based on information on atmospheric environment around the refrigerator measured by the sensor 170 and predetermined environment information stored in the memory 140. The heater 160 may be disposed by being segmented into the plurality of regions 160-n, and each of the plurality of regions 160-n of the heater 160 may be independently driven. The plurality of fans 131 may also be provided, and each of the plurality of fans 131-n may be independently driven. Meanwhile, driving of the fan 131 and the heater 160 may be automatically controlled by the processor 150, or the user may directly manipulate whether to drive the fan 131 and the heater 160 and an operation intensity thereof as necessary.

The description above describes that the fan 131 is driven first and the heater 160 is then driven. However, the present disclosure is not necessarily limited thereto, and the heater 160 may be driven first and the fan 131 may then be driven.

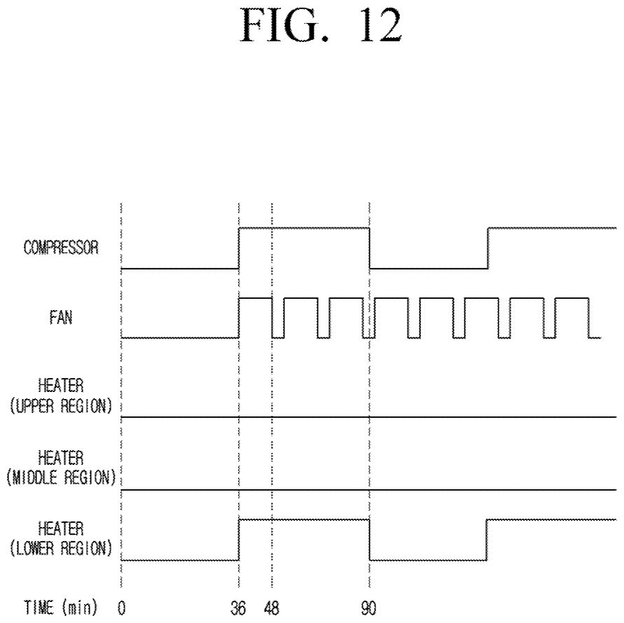

FIG. 12 illustrates an example of a control signal by which the processor controls the respective components based on a sensing result value sensed by the humidity sensor. Specifically, FIG. 12 illustrates, as a reference, a state in which the humidity mode is 7 and the external air temperature is 28 to 33° C. (see Tables 1, 2, and 3).

Referring to FIG. 12, the processor 150 may drive a compressor (not shown) and the lower heater region 160-3 at an operation rate of 40% every 90-minute cycle. While driving the compressor, the processor 150 may simultaneously drive the fan 131 at 60% in a 20-minute cycle without delay, and maintain the upper and middle heater regions 160-1 and 160-2 in an off state.

The description above separately describes the various embodiments of the present disclosure. However, the respective embodiments are not necessarily implemented alone, and the configurations and operations in the respective embodiments may be implemented in combination with at least one another embodiment.

For example, the refrigerator 100 may be implemented to include only the heater 160 disposed on the rotation bar 120, may be implemented to include only the fan 131 disposed on the top cover 130, or may be implemented to include all the heater 160 and the fan 131.

According to the various embodiments of the present disclosure as described above, dew condensation may be effectively prevented from occurring in a specific region such as the rotation bar 120 in the refrigerator 100.

In addition, although the various embodiments of the present disclosure have been illustrated and described above, the present disclosure is not limited to the above-described specific embodiments, and may be variously modified by those skilled in the art to which the present disclosure pertains without departing from the scope of the present disclosure as claimed in the accompanying claims. These modifications should also be understood to fall within the spirit of the present disclosure.

What is claimed is:

1. A refrigerator comprising:
a main body having a storage chamber;
two doors rotatably connected to the main body and each configured to open or close the storage chamber;
a rotation bar disposed on at least one of the two doors and configured to seal a space between the two doors when the two doors close the storage chamber; and
a top cover disposed on an upper portion of the main body,
wherein the top cover comprises:
a suction port configured to allow communication between an inner space of the top cover and an outside of the top cover, and
a fan configured to suction external air through the suction port and discharge the external air toward the rotation bar.

2. The refrigerator as claimed in claim 1, further comprising at least one processor,
wherein the rotation bar includes a heater, and
wherein the at least one processor is configured to control at least one of the fan and the heater.

3. The refrigerator as claimed in claim 2, wherein the heater is disposed along a length direction of the rotation bar and is segmented into a plurality of regions, and
the at least one processor is configured to individually adjust an intensity of each of the plurality of regions of the heater based on a vertical distance between the top cover and each of the plurality of regions of the heater.

4. The refrigerator as claimed in claim 3, wherein the top cover further includes a sensor configured to measure at least one of temperature or humidity, and
the at least one processor is configured to determine whether to drive the fan and each of the plurality of regions of the heater based on a measurement value obtained from the sensor.

5. The refrigerator as claimed in claim 3, wherein the rotation bar further includes a plurality of sensors respectively disposed in the plurality of regions and configured to measure at least one of temperature or humidity, and
wherein the at least one processor is configured to individually adjust the intensity of each of the plurality of regions of the heater based on a measurement value obtained from each of the plurality of sensors.

6. The refrigerator as claimed in claim 1, wherein the fan is disposed at a center of the top cover corresponding to an upper end of the rotation bar, and
wherein the fan includes a discharge port configured to directly discharge air flow toward the rotation bar.

7. The refrigerator as claimed in claim 1, wherein the fan includes a plurality of fans,
wherein the plurality of fans are disposed symmetrically on both sides of a center of the top cover,
wherein the top cover further includes an air flow path connected to each of the plurality of fans to deliver the external air toward the rotation bar, and
wherein the at least one processor is configured to independently drive each of the plurality of fans.

8. A method for preventing dew condensation in a refrigerator, the method comprising:
measuring at least one of temperature or humidity of external air around the refrigerator;
driving a fan disposed on a top cover to introduce the external air toward a rotation bar that seals a space between a first door and a second door of the refrigerator when a sensing value for the external air deviates from a predetermined environment condition; and
driving a heater included in the rotation bar to prevent dew condensation from occurring on the rotation bar.

9. The method as claimed in claim 8, wherein the heater is disposed along a length direction of the rotation bar and is segmented into a plurality of regions, and
wherein driving the heater to prevent the dew condensation from occurring on the rotation bar comprises:
independently driving each of the plurality of regions of the heater to allow an intensity of the heater to increase in proportion to a vertical distance between the top cover and each of the plurality of regions of the heater.

10. The method as claimed in claim 9, wherein driving the heater to prevent the dew condensation from occurring on the rotation bar comprises:
identifying at least one of the temperature or the humidity based on sensing values obtained from a plurality of sensors respectively disposed in the plurality of regions; and
adjusting an individual intensity of each of the plurality of regions of the heater based on the at least one of the temperature or the humidity.
